(19) United States
(12) Patent Application Publication
(10) Pub. No.: US 2015/0313788 A1
(43) Pub. Date: Nov. 5, 2015

(54) METHOD AND DEVICE FOR THERAPEUTIC TREATMENT OF ILIOTIBIAL BAND SYNDROME, MYOFASCIAL AND MUSCULOSKELETAL DYSFUNCTIONS

(71) Applicants: Melissa Nicol CONTE, New York, NY (US); Peter KESSLER, New York, NY (US)

(72) Inventors: Melissa Nicol CONTE, New York, NY (US); Peter KESSLER, New York, NY (US)

(21) Appl. No.: 14/704,548

(22) Filed: May 5, 2015

Related U.S. Application Data
(60) Provisional application No. 61/988,621, filed on May 5, 2014.

(51) Int. Cl. A61H 9/00

(52) U.S. Cl. CPC A61H 9/0057; A61H 2009/0064; A61H 2201/1685; A61H 2201/0153; A61H 2205/102

(57) ABSTRACT

A therapeutic treatment system that embodies a therapeutic method and a medical device for the treatment of Iliotibial Band Syndrome (ITBS), myofascial and/or musculoskeletal dysfunctions by utilizing negative pressure and suction to concurrently lift, lengthen, separate and stretch the iliotibial band to restore it to its correct functional length is provided. The medical device may include a suction implement coupled to an actuator handle, wherein the suction implement may be dimensioned and adapted to generate a negative pressure along a predetermined region requiring treatment. The user may operate the actuator handle so as to move it toward and away from the suction implement so that the suction implement is alternately deformed and returned to an undeformed condition, thereby alternately applying the negative pressure and suction to the predetermined region.

### CROSS-REFERENCE TO RELATED APPLICATION

This application claims the benefit of priority of U.S. provisional application No. 61/988,621, filed 05-MAY-2014, the contents of which are herein incorporated by reference.

### BACKGROUND OF THE INVENTION

The present invention relates to medical devices for therapeutic treatment and, more particularly, to a method and device for therapeutic treatment of Iliotibial Band Syndrome (ITBS), myofascial and musculoskeletal dysfunctions.

The iliotibial band is a band of thick fibrous fascia tissue which extends from the outside of the pelvis over the hip to just below the knee. The iliotibial band is essential for stabilizing the knee joint during both dynamic and static postures. Several biomechanical and or structural factors can cause a shortening and tightening of the iliotibial band, including becoming taut and swollen from excess repetitive movement of the knee, urging induced friction or irritation of the iliotibial band as it moves over the thigh bone (femur) from its anatomically correct position creating ITBS. ITBS, which is a very common condition or injury, can cause persistent pain, inflammation and swelling in both the distal (lateral knee) and proximal (lateral hip) sites of attachment.

Traditional methods of treating ITBS such as foam rolling, stretching and strengthening the iliotibial band have not addressed the underlying structural problem of ITBS. With ITBS, the iliotibial band will often get adhered to the lateral aspect of the quadriceps muscle which will cause pain and decrease mobility of the knee and or hip region. The only means by which to separate the iliotibial band from the lateral aspect is by utilizing negative pressure and suction to lift the iliotibial band off the surrounding tissue.

While these outdated methods for attempting to treat ITBS might, at best, bring about temporary relief, they rarely effect a permanent cure, in that despite the use of the existing methods for treating ITBS, such as intense massage, stretching, or strengthening the affected iliotibial band through exercise, the flexibility of the iliotibial band does not change, thus refuting the employment of the prevailing therapies in use.

Because the iliotibial band is not a muscle, in order to break up scar tissue, adhesions and trigger points, one must use negative pressure and suction to gain relief from the above mentioned tissue disorders. In short, the current therapeutic modalities do not lift and separate the iliotibial band from its surrounding myofascial structures necessary for treating ITBS.

As can be seen, there is a need for a method and device for therapeutic treatment of ITBS, myofascial and musculoskeletal dysfunctions by utilizing negative pressure and suction to concurrently lift, lengthen, separate and stretch the iliotibial band to restore it to its correct functional length.

### SUMMARY OF THE INVENTION

In one aspect of the present invention, a medical device for the treatment of iliotibial band syndrome includes a suction implement having a rounded bowl-like configuration, forming an open cavity which opens outwardly through an open end; and an actuator handle coupled to the suction implement.

In another aspect of the present invention a method of therapeutically treating iliotibial band syndrome along a predetermined region, includes the steps of providing a medical device having a suction implement providing a rounded bowl-like configuration, forming an open cavity which opens outwardly through an open end; and an actuator handle coupled to the suction implement; urging a sealing engagement between the open end and the predetermined region; moving the actuator handle toward and away from the suction implement so that the suction implement is alternately deformed and returned to an undeformed condition, whereby the resulting negative pressure and suction breaks up scar tissue, adhesions and trigger points of a subject iliotibial band.

These and other features, aspects and advantages of the present invention will become better understood with reference to the following drawings, description and claims.

### BRIEF DESCRIPTION OF THE DRAWINGS

FIG. 1 is a top perspective view of an exemplary embodiment of the present invention;

FIG. 2 is a top view of an exemplary embodiment of the present invention;

FIG. 3 is a bottom view of an exemplary embodiment of the present invention;

FIG. 4 is a bottom perspective view of an exemplary embodiment of the present invention;

FIG. 5 is a side view of an exemplary embodiment of the present invention,

FIG. 6 is a section view of an exemplary embodiment of the present invention, taken along line 6-6 in FIG. 5;

FIG. 7 is an exploded view of an exemplary embodiment of the present invention;

FIG. 8 is a section view demonstrating the location of the iliotibial band;

FIG. 9 is a perspective view of an exemplary embodiment of the present invention, shown in use;

FIG. 10 is a perspective view of an exemplary embodiment of the present invention, shown in use;

FIG. 11 is a detailed section view of an exemplary embodiment of the present invention, taken along line 11-11 in FIG. 10, shown in use;

FIG. 12 is a top view of an exemplary embodiment of the present invention;

FIG. 13 is a detailed section view of an exemplary embodiment of the present invention, taken along line 13-13 in FIG. 12, shown in use;

FIG. 14 is a top perspective view of an exemplary embodiment of the present invention;

FIG. 15 is a bottom perspective view of an exemplary embodiment of the present invention;

FIG. 16 is a top view of an exemplary embodiment of the present invention; and

FIG. 17 is a bottom view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a therapeutic treatment system that embodies a therapeutic method and a medical device for the treatment of Iliotibial Band Syndrome (ITBS), myofascial and/or musculoskeletal dysfunctions by utilizing negative pressure and suction to concurrently lift, lengthen, separate and stretch the iliotibial band to restore it to its correct functional length. The medical device may include a suction implement coupled to an actuator handle, wherein the suction implement may be dimensioned and adapted to generate a negative pressure along a predetermined region requiring treatment. The user may operate the actuator handle so as to move it toward and away from the suction implement so that the suction implement is alternately deformed and returned to an undeformed condition, thereby alternately applying the negative pressure and suction to the predetermined region.

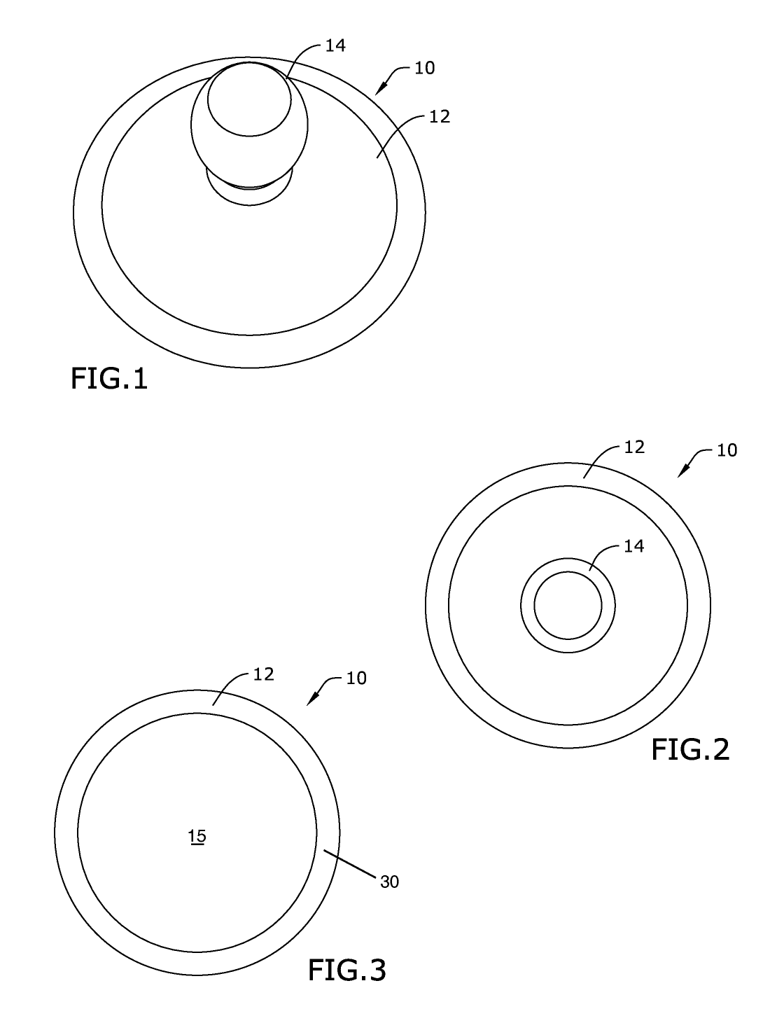

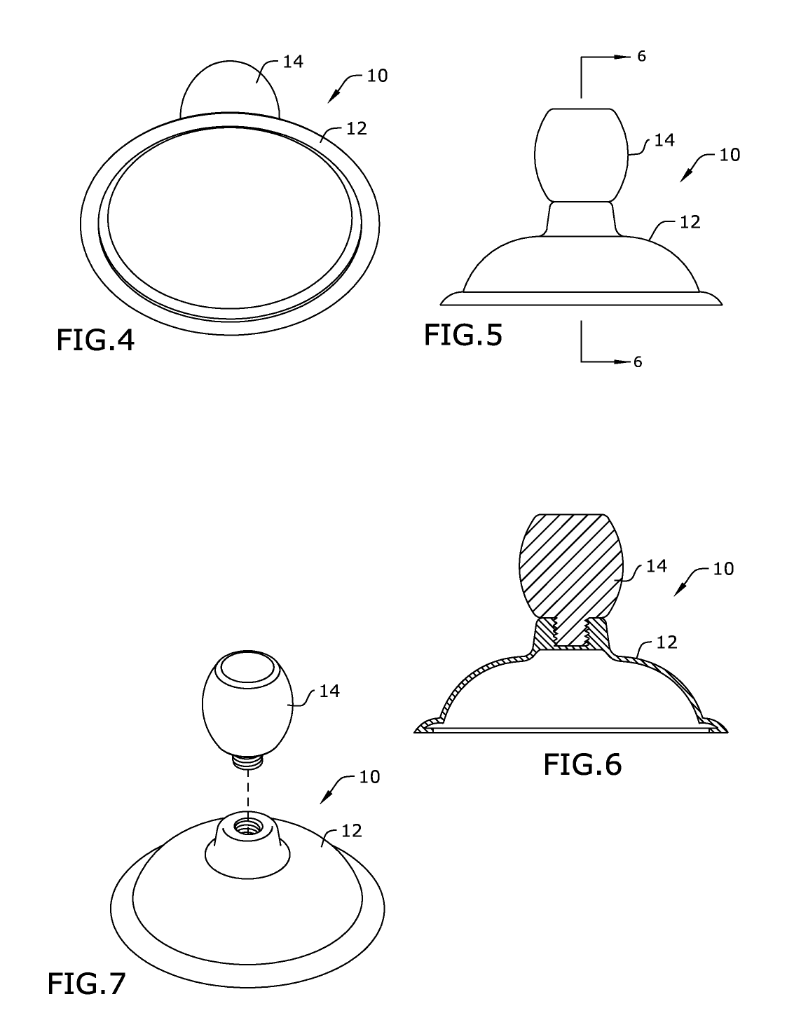

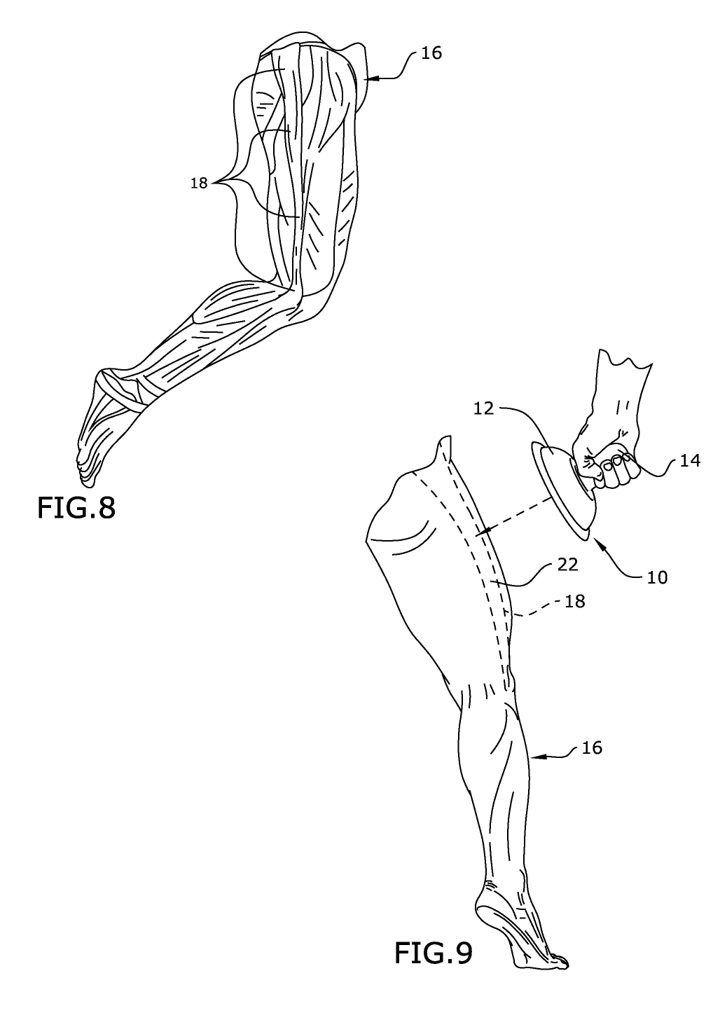

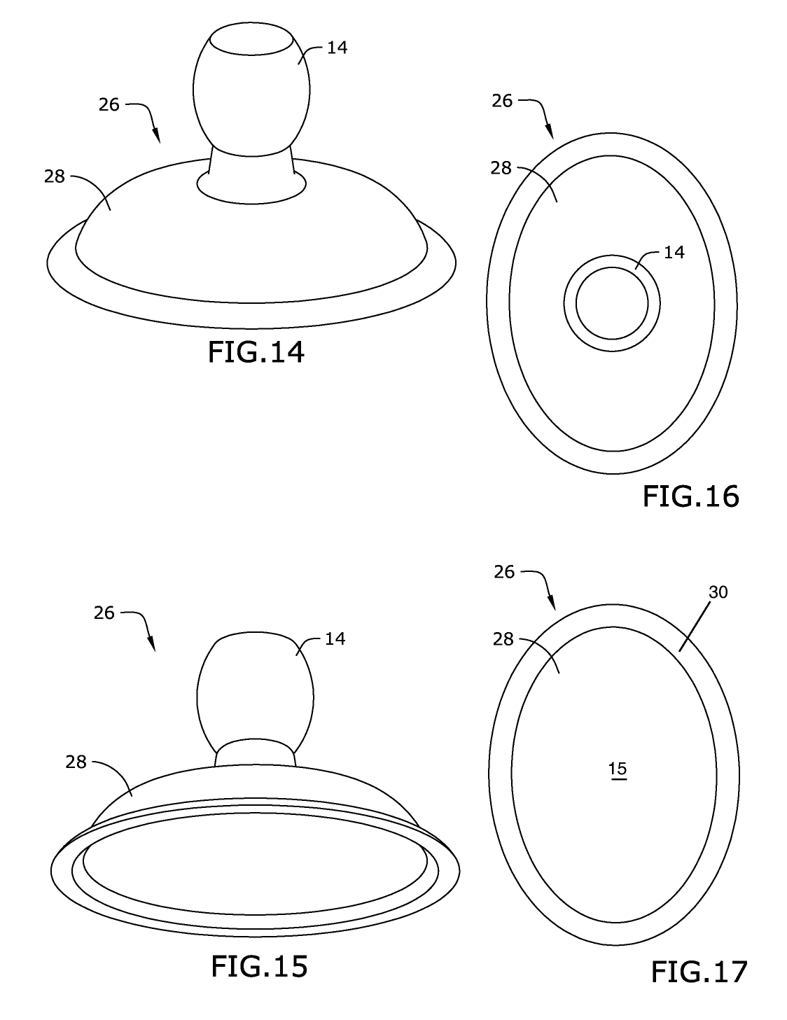

Referring to FIGS. 1 through 17, the present invention may include a therapeutic treatment system that embodies a therapeutic method and medical device 10 for treatment of ITBS, myofascial and/or musculoskeletal dysfunctions by utilizing negative pressure and suction to concurrently lift, lengthen, separate and stretch the iliotibial band 18 to restore it to its correct functional length.

The medical device 10 may include a suction implement 12 coupled to an actuator handle 14. The suction implement 12 may be dimensioned and adapted to generate a negative pressure and suction along a predetermined region 24. The predetermined region 24 may include a portion of soft tissue 20, iliotibial band 18, and skin 22 of a leg of a user 16 that is affected by iliotibial band syndrome, myofascial dysfunctions, musculoskeletal dysfunctions, and other tissue disorders.

The suction implement 12 may be made of a thermoplastic elastomer (TPE), thermoplastic rubber or suitable resiliently deformable material that is suitable for injection molding, recyclable, and does not require chemical agents for reinforcement, stabilization or curing.

The suction implement 12 may be a substantially rounded or elliptical bowl-like configuration, forming an open cavity which opens outwardly through an open end 15. The bowl-like configuration may form an opening rim 30 circumscribing the open end 15. The suction implement may be adapted so as to generate negative pressure and suction along the predetermined region 24. The open end 15 of the suction implement 12 may be shaped generally circular, elliptical 26, 28 or the like, as illustrated in FIGS. 3 and 17, so that the present invention functions as disclosed herein. The opening rim 13 and open end 15 may be dimensioned and adapted to form a substantially sealed engagement with the predetermined region 24 and apply sufficient pressures thereto so as to lift, lengthen and stretch the subject soft tissue areas, such as the iliotibial band 18.

The spindle-shaped actuator handle 14 may can be material that can be repeatedly bent without fracturing, such as wood, acrylic, plasticized, laminated and other material. The actuator handle 14 may include a spherical, knob-like grip on its top to increase hand stability with improved ergonomics and operation for carrying out the repetitive pumping motion that actuates the suction implement 12. The actuator handle 14 may be coupled to the suction implement 12 by, for example, but not limited to complementary threading, as illustrated in FIG. 6.

The actuator handle 14 may be adapted to administer the negative pressure and suction by means of the suction implement 12 coupled to the actuator handle 14, which, when actuated in a repetitive pumping motion, lifts, lengthens and stretches the subject soft tissue areas, such as the iliotibial band 18. Such negative pressure and suction may be adapted to increase blood flow and circulation as the suction implement 12 is moved along the predetermined region 24

A method of using the present invention may include the following. The therapeutic treatment system disclosed above may be provided. The therapeutic treatment system is adapted to be easy and thoroughly safe for use by laypeople in any setting without any medical knowledge or prior experience in treating the aforementioned conditions, injuries, other related myofascial and musculoskeletal dysfunctions.

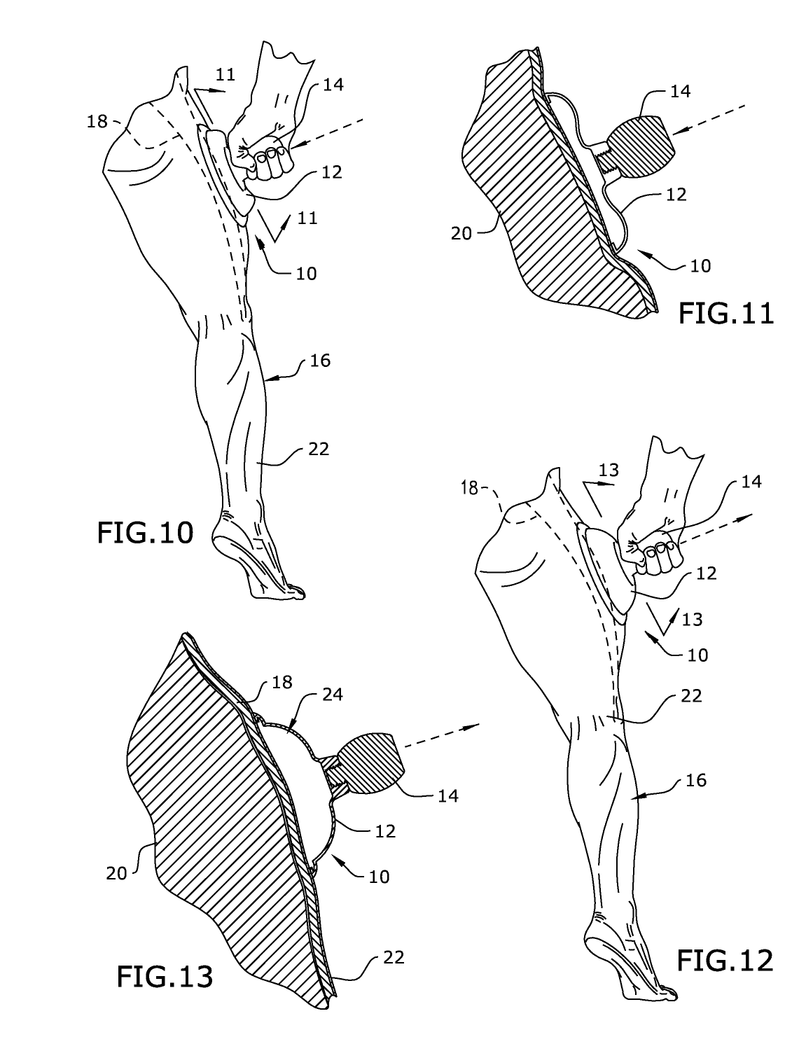

A user may urge the open end 15/opening rim 30 of the open cavity onto the predetermined region 24 so as to form a sufficient sealing engagement, as illustrated FIG. 10. Then the user may operate the actuator handle 14 so as to move it toward and away from the suction implement 12 so that the suction implement 12 is alternately deformed, FIG. 11, and returned to an undeformed condition, FIG. 13, in order to alternately apply pressure and suction to the predetermined region 24 whereby the pressure and suction breaks up scar tissue, adhesions and trigger points of the iliotibial band 18 or other soft tissue.

In certain embodiments, a commercially available semi viscous, water permeable liquid preparation may be rubbed on at least a portion of the predetermined region 24 as a medium by which to promote an improved yet temporary airtight sealing engagement between the opening rim 30 and the soft tissue, thus yielding enhanced negative pressure and suction. Unlike earlier forms of treatment, use of the present invention will relax excessive tissue contractions and reduce inflammation, diminishing pain and eliminate harmful toxins from local regions while concomitantly generating and resupplying essential nutrients necessary for healing.

In conjunction with also providing relief for other related myofascial and musculoskeletal dysfunctions, the present invention may be effective for treating chronic IT Band Tendinitis, Patellar Tendinitis, Patellofemoral Pain Syndrome along with Knee Bursitis, and aids in stimulating blood flow and circulation while diminishing persistent protuberant knots and sections of rigid tissue.

The method of making the present invention may include the following. The suction implement 12 may be made cost effectively manufactured by means of injection molding, which entails injecting the raw/liquefied resilient material (TPE) into a mold cavity to shape the compound into the predetermined form. The actuator handle 14 may be coupled to the suction implement 12 through mating complementary threading.

It should be understood, of course, that the foregoing relates to exemplary embodiments of the invention and that modifications may be made without departing from the spirit and scope of the invention as set forth in the following claims.

What is claimed is:

1. A medical device for the treatment of Iliotibial Band Syndrome, comprising:
a suction implement; and
an actuator handle coupled to the suction implement.

2. The medical device of claim 1, wherein the suction implement further comprises:
a rounded bowl-like configuration, forming an open cavity which opens outwardly through an open end; and
a handle end opposing the open end, wherein the actuator handle is coupled to the handle end.

3. The medical device of claim 2, further comprising:
a threaded opening formed on the handle end; and
a threading disposed along a portion of the actuator handle, wherein the threading and the threaded opening complementarily mate when coupled.

4. The medical device of claim 3, wherein the open end is generally circular.

5. The medical device of claim 3, wherein the open end is generally elliptical.

6. A method of therapeutically treating Iliotibial Band Syndrome along a predetermined region, comprising the steps of:
providing a medical device comprising:
a suction implement having a rounded bowl-like configuration, forming an open cavity which opens outwardly through an open end; and
an actuator handle coupled to the suction implement;
urging a sealing engagement between the opening rim and a portion of the predetermined region; and
moving the actuator handle toward and away from the suction implement so that the suction implement is alternately deformed and returned to an undeformed condition,
whereby the resulting negative pressure and suction lifts, lengthens and or stretches a subject iliotibial band.

7. The method of claim 6, further comprising positioning the sealing engagement over a plurality of predetermined regions along the length of the subject iliotibial band.

8. The method of claim 6, furthering comprising an initial step of rubbing semi viscous, water permeable liquid preparation on at least a portion of the predetermined region.
